(19) United States
(12) Patent Application Publication
(10) Pub. No.: US 2010/0068685 A1
(43) Pub. Date: Mar. 18, 2010

(54) SYSTEM FOR EVALUATING COGNITIVE ABILITY OF A SUBJECT

(76) Inventor: Ching-Fen JIANG, Kaohsiung County (TW)

Correspondence Address: REED SMITH LLP, P.O. BOX 488, PITTSBURGH, PA, 15230-0488, US

(21) Appl. No.: 12/624,592

(22) Filed: Nov. 24, 2009

(30) Foreign Application Priority Data
Jun. 13, 2008 (TW) 097122191

(51) Int. Cl. G09B 19/00

(52) U.S. Cl. 434/236

(57) ABSTRACT

A system for evaluating cognitive ability of a subject includes a display unit, an input unit, and a way-finding test module including a database and a test processor. The database stores two-dimensional map data and a three-dimensional model of a virtual environment. The three-dimensional model is comprised of surface elements representing features visible in the virtual environment. The test processor is operable to control the display unit to generate a map image corresponding to the two-dimensional map data during an initial stage of a way-finding test. The input unit is operable by the subject during a subsequent stage of the way-finding test to provide control signals to the test processor. The test processor is responsive to the control signals to select the surface elements corresponding to the features in the virtual environment that become visible, and to control the display unit to generate three-dimensional animation.

### BACKGROUND OF THE INVENTION

1. Field of the Invention

The present invention relates to a system for evaluating cognitive ability of a subject, more particularly to a system for evaluating cognitive ability of a subject that is capable of interaction with the subject.

2. Description of the Related Art

Alzheimer's disease, brain damage, and various common mental diseases and psychoses, such as schizophrenia, depression, attention deficit and hyperactivity disorder, autism, etc., usually accompany cognitive decline. For such diseases, evaluation of cognitive ability is significant, and appropriate therapies can be initiated to reduce further cognitive decline. However, the evaluation of cognitive ability involves a variety of individual tests, such as Clinical Dementia Rating (CDR), Mini-Mental State Examination (MMSE), Continuous Performance Test (CPT), Wisconsin Card Sorting Test (WCST), etc. Since each of the above-mentioned tests is implemented individually, it is inconvenient for a therapist to integrate results from different tests.

Moreover, there is a requirement of relatively efficient and reliable tools to evaluate the cognitive ability in a three-dimensional (3D) space, since the 3D spatial cognitive decline is commonly associated with Alzheimer's disease. Therefore, aside from the above tests, Wechsler Intelligence Scale is commonly used for evaluating the cognitive ability in the 3D space. Wechsler Intelligence Scale involves building blocks used for evaluating positioning ability in the 3D space. However, such test does not provide a 3D space for training the cognitive ability of the subject in the 3D space.

### SUMMARY OF THE INVENTION

Therefore, an object of the present invention is to provide a system for evaluating cognitive ability of a subject that is capable of interaction with the subject.

According to the present invention, a system for evaluating cognitive ability of a subject comprises a display unit, an input unit, and a way-finding test module coupled to the display unit and the input unit.

The way-finding test module includes a database and a test processor. The database stores two-dimensional map data of a virtual environment that includes a starting point, an end point, and a test route defined from the starting point to the end point. The database further stores a three-dimensional model of the virtual environment. The three-dimensional model is comprised of surface elements representing features visible in the virtual environment. The test processor is operable to control the display unit to generate a map image corresponding to the two-dimensional map data of the virtual environment during an initial stage of a way-finding test.

The input unit is operable by the subject during a subsequent stage of the way-finding test to provide control signals to the test processor for traversing a traveling route in the virtual environment. The traveling route starts from the starting point and ends at the end point. The test processor is responsive to the control signals from the input unit to select from the three-dimensional model the surface elements corresponding to the features in the virtual environment that become visible as the traveling route is traversed, and to control the display unit to generate three-dimensional animation of the traveling route that is being traversed based on the surface elements selected thereby. The test processor further measures the duration taken by the subject to traverse the traveling route, and compares the traveling route with the test route to detect occurrence of the subject getting lost.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a preferred embodiment of a system for evaluating cognitive ability of a subject according to the present invention;

FIG. 2 is a flow chart illustrating stages of a way-finding test implemented by the system of the present invention;

FIG. 3 is a schematic diagram illustrating an access interface for accessing the way-finding test;

FIG. 4 is a map image shown on a display unit of the system of the present invention during an initial stage of the way-finding test;

FIG. 5 shows 3D animation of a traveling route that is being traversed during a subsequent stage of the way-finding test;

FIG. 6 is an evaluation result that is immediately generated by an evaluation module of the system of the preferred embodiment and that is associated with the way-finding test;

FIG. 7 is another evaluation result associated with the way-finding test for illustrating an incomplete result due to getting lost;

FIG. 8 is a schematic diagram illustrating a first setting interface associated with a sustained attention test;

FIG. 9 is a schematic diagram illustrating a second setting interface associated with a three-dimensional spatial cognitive test;

FIG. 10 is a schematic diagram illustrating a virtual three-dimensional space associated with the three-dimensional spatial cognitive (3DSC) test;

FIG. 11 is a schematic diagram illustrating a third setting interface associated with a set-shifting test;

FIG. 12 is a schematic diagram illustrating a virtual three-dimensional scene associated with a sense-of-direction test;

FIG. 13 is a schematic diagram illustrating a selection interface for selecting and activating a selected one of a plurality of test modules of the system;

FIG. 14 is a record that is stored by a response recording module of the system of the preferred embodiment and that is associated with the 3DSC test;

FIG. 15 is the evaluation result associated with the 3DSC test;

FIG. 16 is the evaluation result associated with the sense-of-direction test; and

FIG. 17 is a comparison table to compare cognitive ability evaluating tests implemented by conventional ways and those implemented by the system of the preferred embodiment.

### DETAILED DESCRIPTION OF THE PREFERRED EMBODIMENT

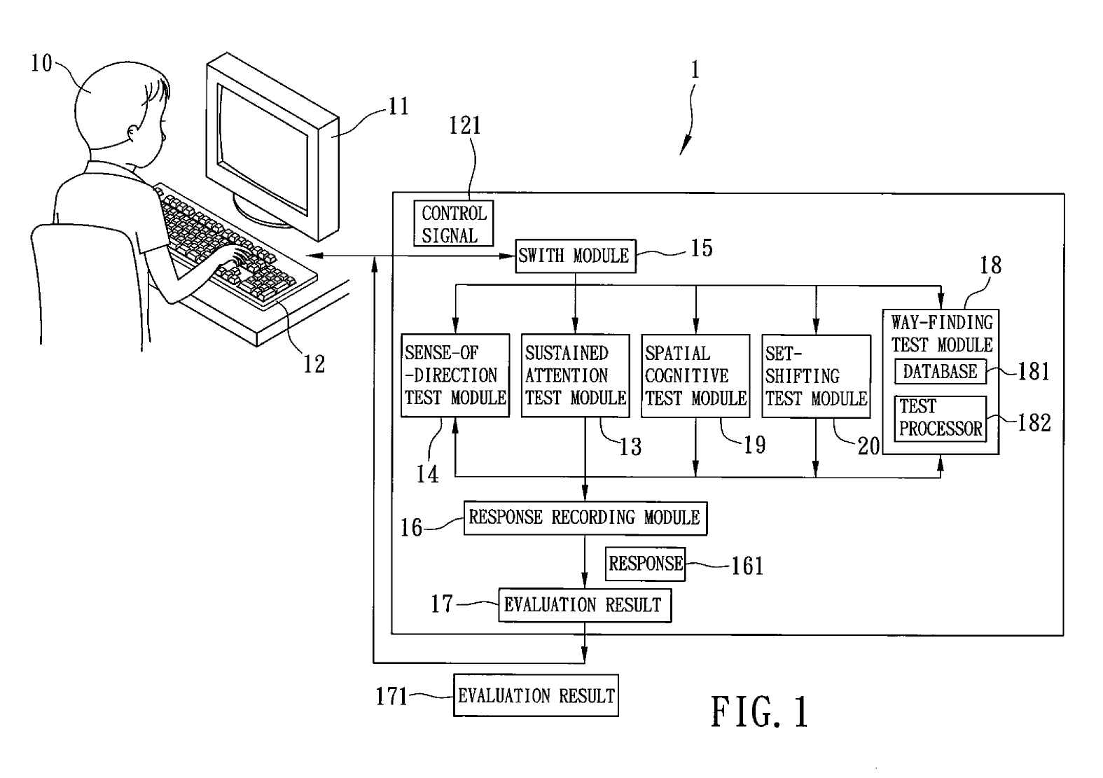

Referring to FIG. 1, the preferred embodiment of a system 1 for evaluating cognitive ability of a subject 10 according to this invention includes a display unit 11, an input unit 12, a way-finding test module 18, a response recording module 16, and an evaluation module 17.

In this embodiment, the display unit 11 is a liquid crystal display device, a cathode ray tube screen, or any other display modules. The input unit 12 is operable by the subject 10 during a test provided by the system 1 to provide control signals 121. The input unit 12 includes at least a keyboard, a mouse or a joystick, or any other apparatus capable of inputting. The response recording module 16 is coupled to the way-finding test module 18 for storing responses 161 made by the subject 10 through the input unit 12 when taking tests. The evaluation module 17 stores a plurality of sets of comparison data, receives the responses 161 from the response recording module 16, and compares the responses 161 with the comparison data to generate an evaluation result 171.

The way-finding test module 18 is coupled to the display unit 11 and the input unit 12, and includes a database 181 and a test processor 182. The database 181 stores two-dimensional map data of a virtual environment that includes a starting point, an end point, and a test route defined from the starting point to the end point. The database 181 further stores a three-dimensional (3D) model of the virtual environment. The 3D model is comprised of surface elements representing features visible in the virtual environment.

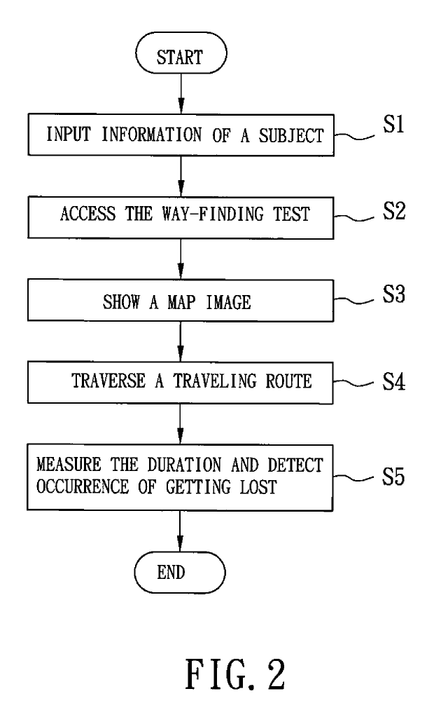

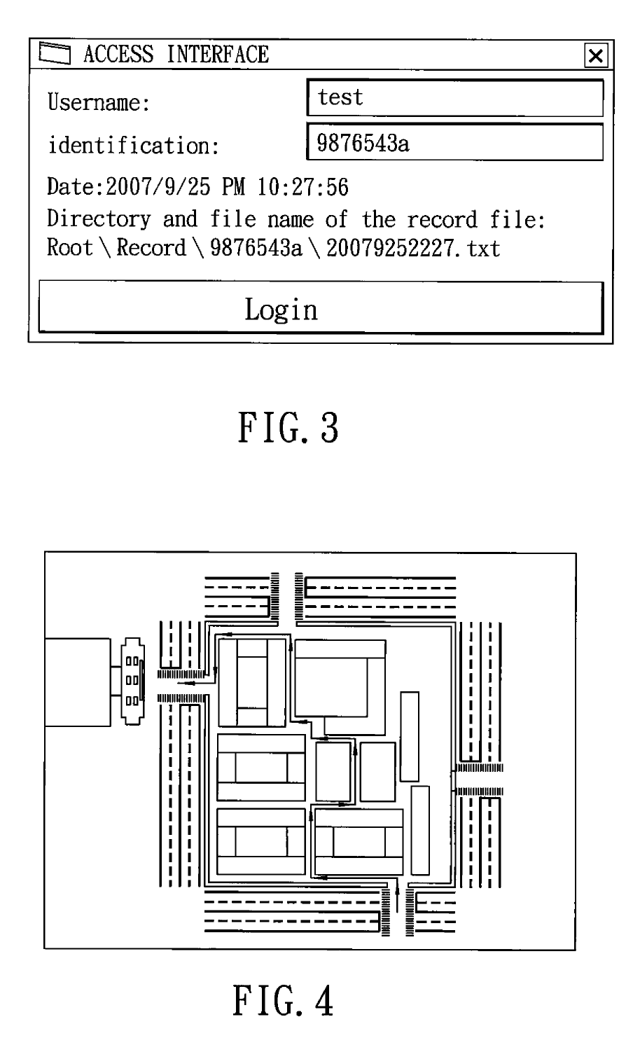

Further referring to FIGS. 2 to 5, the test processor 182 controls the display unit 11 to provide an access interface (as shown in FIG. 3) to the subject 10 for inputting information of the subject 10 in step (S1). Then, in step (S2), the subject 10 accesses a way-finding test through the access interface. In step (S3), the test processor 182 further controls the display unit 11 to generate a map image (shown in FIG. 4) corresponding to the two-dimensional map data of the virtual environment stored in the database 181 of the way-finding test module 18. The map image shows the subject 10 the test route (indicated by arrows in FIG. 4) from the starting point to the end point.

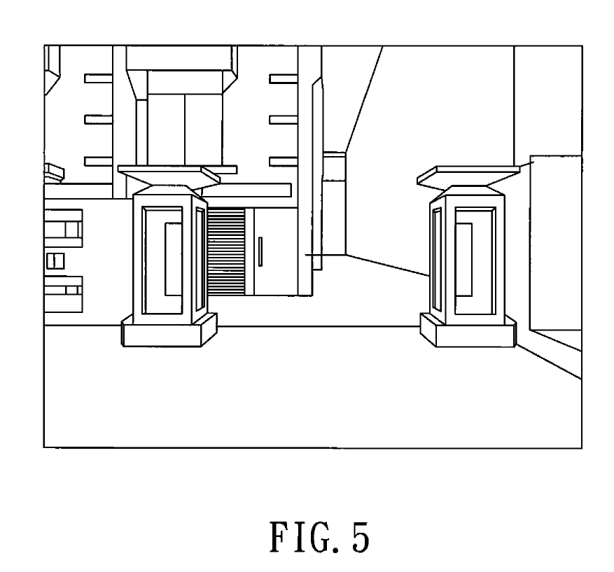

Subsequently, in step (S4), the subject 10 operates the input unit 12 for traversing a traveling route starting from the starting point in the virtual environment without the map image shown in FIG. 4. In other embodiments, the map image may be shown for traversing the traveling route in the virtual environment in step (S4). The control unit 12 provides the control signals 121 to the test processor 182 of the way-finding test module 18 based upon the responses made by the subject 10. The test processor 182 is responsive to the control signals 121 from the input unit 12 to select from the 3D model stored in the database 181 of the way-finding test module 18 the surface elements corresponding to the features in the virtual environment that become visible as the traveling route is traversed, and to control the display unit 11 to generate 3D animation of the traveling route that is being traversed based on the surface elements selected thereby, as best shown in FIG. 5. In practice, the subject 10 is required to conduct step (S4) with the same test route at least two times, i.e., with and without landmarks in the 3D animation to evaluate way-finding strategy of the subject 10.

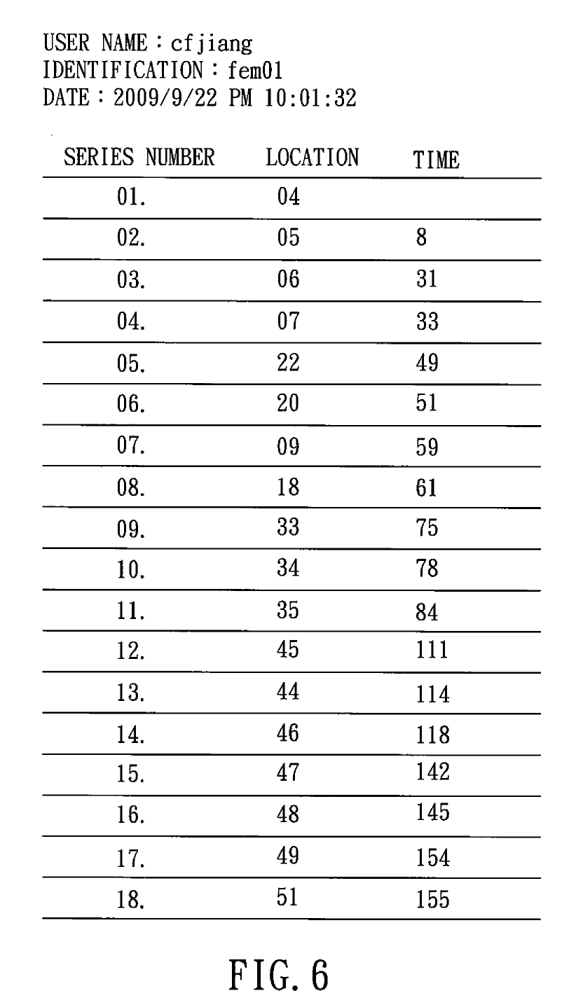

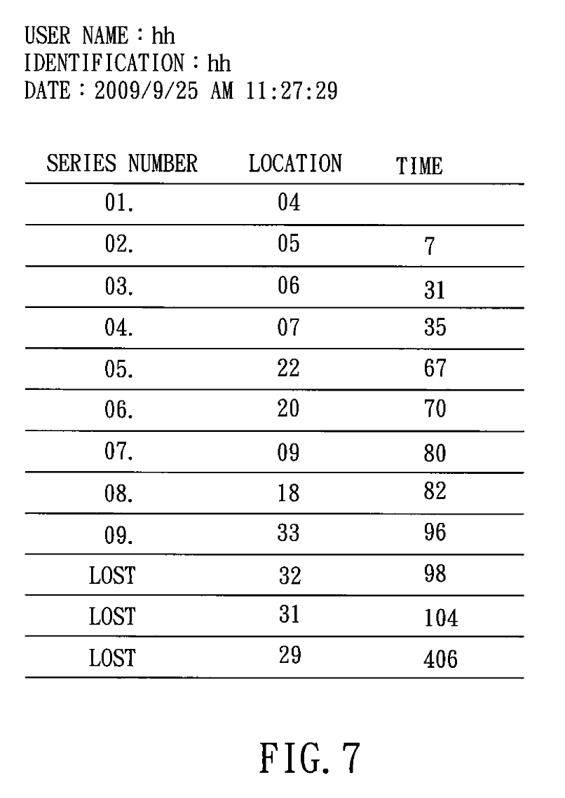

In step (S5), the test processor 182 further measures the duration taken by the subject 10 to traverse the traveling route, and compares the traveling route with the test route to detect occurrence of the subject 10 getting lost. The response recording module 16 stores the responses made by the subject 10 through the input unit 12. The evaluation module 17 receives the responses 161 from the response recording module 16, and compares the responses with the comparison data to immediately generate an evaluation result 171 of the way-finding test as shown in FIGS. 6 and 7. In particular, FIG. 7 shows the evaluation result 171 that the subject 10 got lost. Further, the display unit 11 is operable to show a final image based upon the evaluation result 171 and a record including the responses 161.

Referring again to FIG. 1, the system 1 of this embodiment further includes several auxiliary test modules, including a sustained attention test module 13, a spatial cognitive test module 19, a set-shifting test module 20 and a sense-of-direction test module 14, and a switch module 15. The switch module 15 is coupled to and is operable to activate a selected one of the way-finding test module 18, the sustained attention test module 13, the spatial cognitive test module 19, the set-shifting test module 20, and the sense-of-direction test module 14 when evaluating the cognitive ability of the subject 10. Configurations of the sustained attention test module 13, the spatial cognitive test module 19, the set-shifting test module 20, and the sense-of-direction test module 14 are similar to the configuration of the way-finding test module 18, and details thereof will be omitted herein for the sake of brevity.

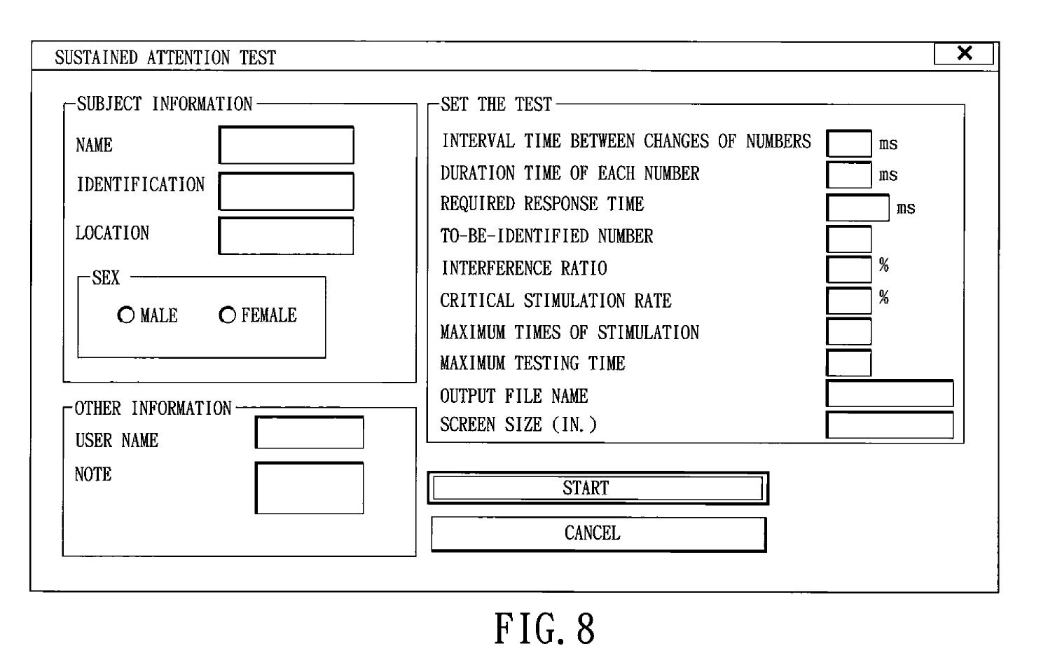

The sustained attention test module 13 controls the display unit 11 to provide a first setting interface as shown in FIG. 8. The first setting interface permits the subject 10 to input personal information and to set parameters of a sustained attention test that is to be implemented by the sustained attention test module 13. Then, the sustained attention test module 13 is configured to implement the sustained attention test. In this embodiment, the sustained attention test is the Continuous Performance Test (CPT). Since the procedure of CPT is well known to those skilled in the art, details thereof will be omitted herein for the sake of brevity.

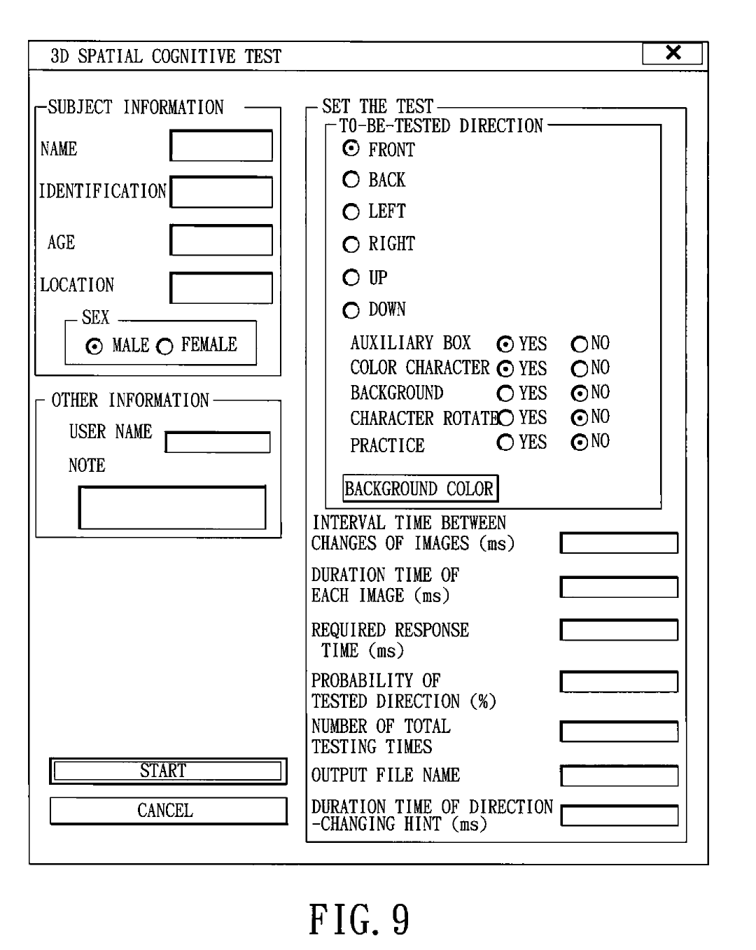

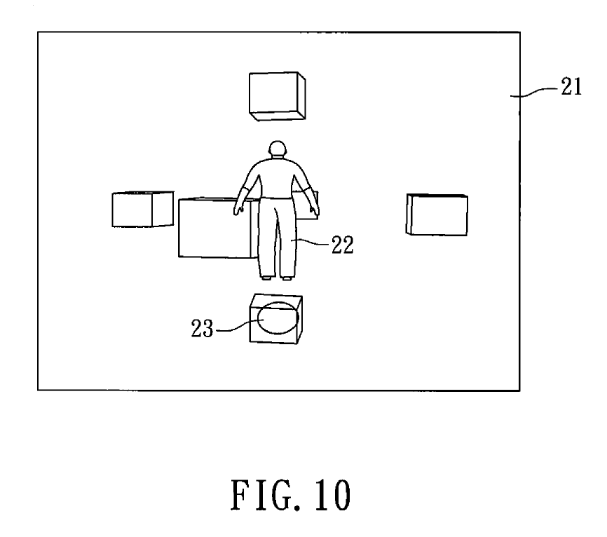

The spatial cognitive test module 19 controls the display unit 11 to provide a second setting interface as shown in FIG. 9. The second setting interface permits setting of parameters of a three-dimensional spatial cognitive (3DSC) test proposed by De-Kai Chen et al. in “Development of a Computer-aided Tool for Evaluation and Training in 3D Spatial Cognitive Function,” Computer-Based Medical Systems, 19th IEEE International Symposium, pages 241-244, 2006. Referring to FIG. 10, the sustained attention test module 13 is configured to implement the 3DSC test, and controls the display unit 11 to generate a virtual 3D space 21 with a first virtual character 22. In the 3DSC test, the subject 10 needs to determine whether a direction of a reference item 23 referring to the first virtual character 22 matches a to-be-tested direction set through the second setting interface shown in FIG. 9.

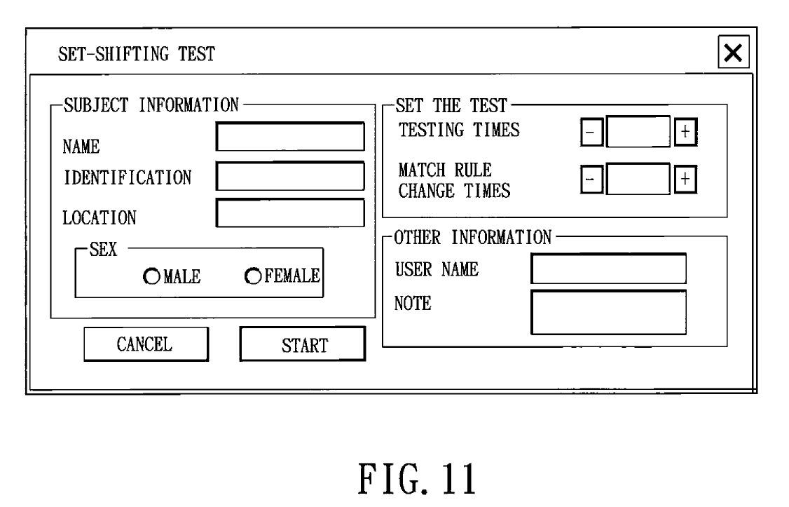

The set-shifting test module 20 controls the display unit 11 to provide a third setting interface as shown in FIG. 11. The third setting interface permits inputting of personal information of the subject 10 and setting parameters of a set-shifting test to be implemented by the set-shifting test module 20. Then, the set-shifting test module 20 is configured to implement the set-shifting test. In this embodiment, the set-shifting test is the Wisconsin Card Sorting Test (WCST). Since the procedure of WCST is well known to those skilled in the art, details thereof will be omitted herein for the sake of brevity.

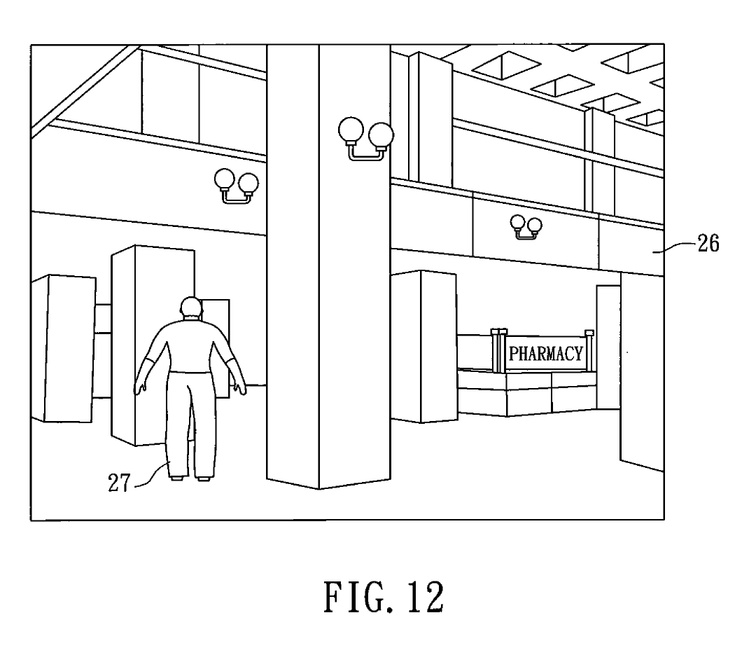

The sense-of-direction test module 14 is configured to implement a sense-of-direction test proposed by Ching-Fen Jiang et al. in “Virtual Hospital-a Computer-Aided Platform to Evaluate the Sense of Direction,” Engineering in Medicine and Biology Society, 29th Annual International Conference of the IEEE, pages 2361-2364, 2007. The sense-of-direction test module 14 controls the display unit 11 to generate a virtual 3D scene 26 with a second virtual character 27 that is capable of moving in the virtual 3D scene 26, as best shown in FIG. 12. In this embodiment, the virtual 3D scene 26 is configured as a hospital. In an initial stage of the sense-of-direction test, the subject 10 controls the input unit 12 to move the second virtual character 27 arbitrarily for exploring the virtual 3D scene 26, and then is requested to move to a particular location in the virtual 3D scene 26, such as a pharmacy in the hospital as shown in FIG. 12. When the virtual character 27 arrives at the particular location, the sense-of-direction test module 14 is further configured to determine response time and an orientation difference that is an angle between a pointing direction of the virtual character 27 and a direction of a previously explored landmark not in the virtual 3D scene 16 for evaluating sense of direction of the subject 10. It should be noted that, in other embodiments, the sense-of-direction test module 14 may also control the display unit 11 to generate the virtual 3D scene 26 that is configured as a first person view associated with the subject 10 and that is without the virtual character 27.

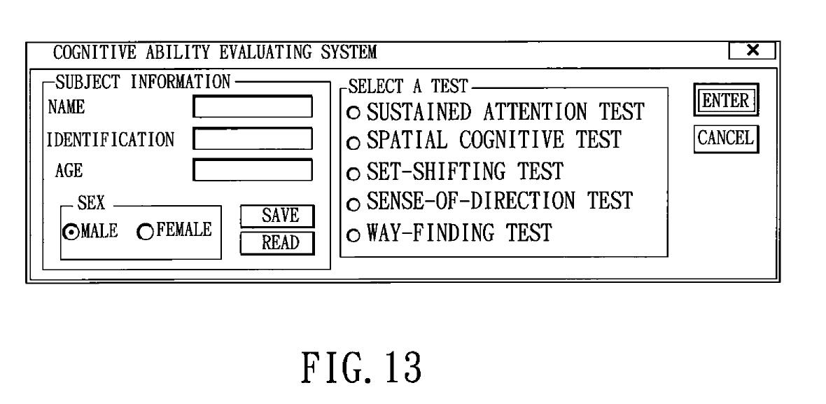

Referring to FIGS. 1 and 13, the switch module 15 is configured to control the display unit 11 to show a selection interface for permitting the subject 10 to select one of the way-finding test, the sustained attention test, the 3DSC test, the set-shifting test, and the sense-of-direction test. In this embodiment, the selection interface further permits inputting of the personal information of the subject 10, and saving the personal information as a particular file.

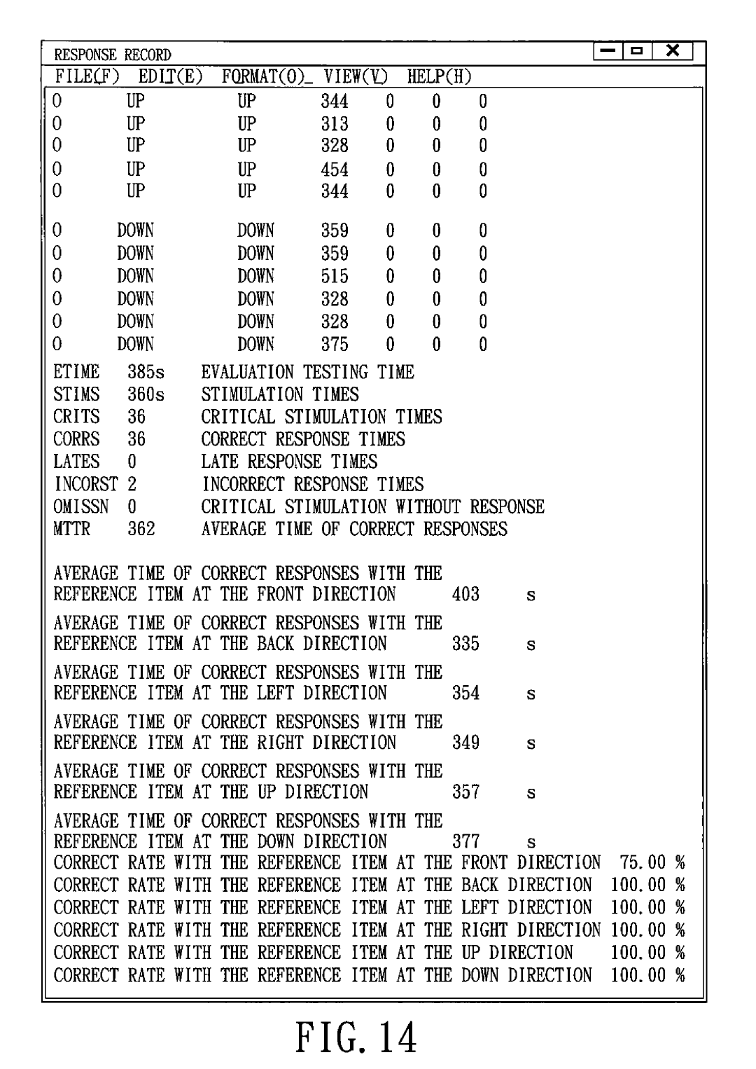

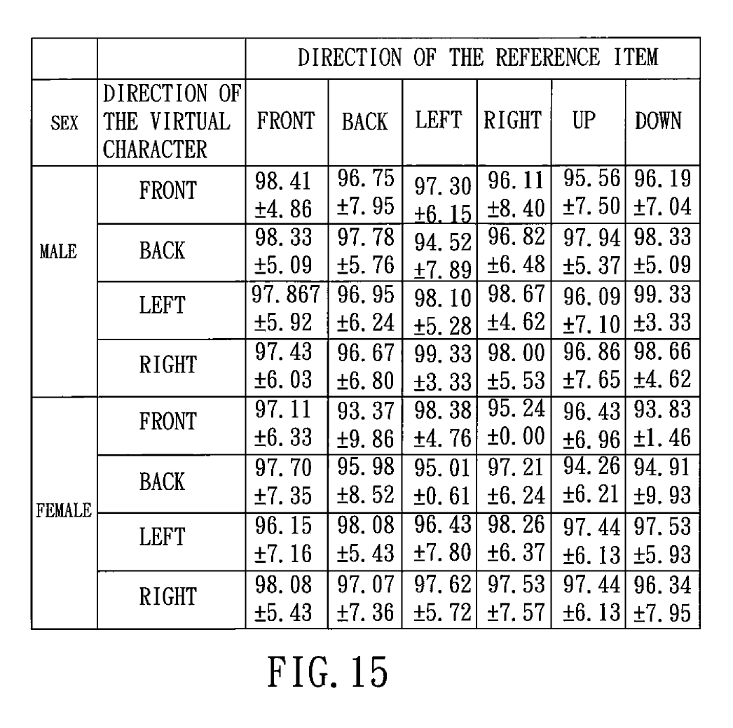

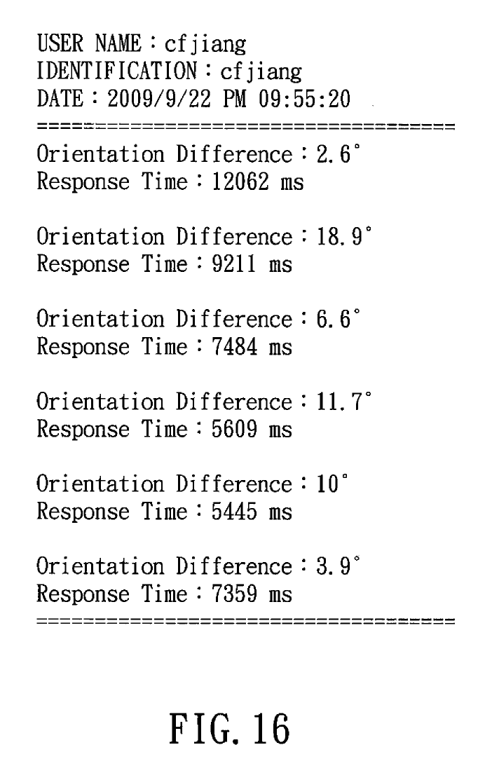

The response recording module 16 is further coupled to the sustained attention test module 13, the spatial cognitive test module 19, the set-shifting test module 20, and the sense-of-direction test module 14 for storing the responses 161 made by the subject through the input unit 12 when taking the tests provided by the test modules 13, 19, 20, 14. It should be noted that the response recording module 16 stores the responses 161 as a text file or other file formats when the subject 10 has completed or terminated a selected one of the tests. For example, FIG. 14 shows the text file of the response 161 associated with the 3DSC test performed by the spatial cognitive test module 19. The evaluation module 17 also stores sets of comparison data corresponding to the various tests, and compares the responses 161 with the comparison data to generate the evaluation result 171, such as the evaluation result of the 3DSC test performed by the spatial cognitive test module 19 shown in FIG. 15, and the evaluation result of the sense-of-direction test shown in FIG. 16.

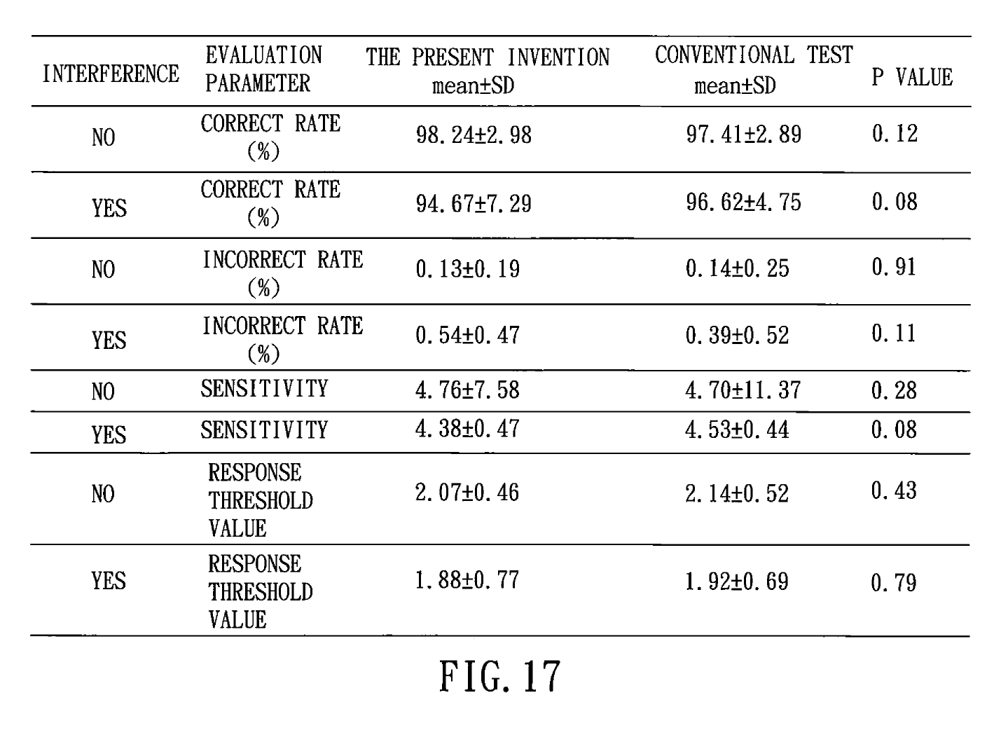

In sum, from a comparison table shown in FIG. 17, it can be seen that the evaluation results from the system 1 considerably conform with evaluation results from conventional tests, and also conform with statistics and results disclosed in related works. Therefore, the system 1 of this invention can properly replace conventional means for evaluating the cognitive ability. Moreover, the system 1 of this invention provides an integrated digital plat form so as to enhance convenience and efficiency for a therapist when recording and evaluating the cognitive ability of the subject 10 and searching a record of the subject 10. Furthermore, the way-finding test module 18 of the system 1 provides the 3D virtual environment for efficiently and reliably evaluating and training the cognitive ability of a subject in a 3D space.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for evaluating cognitive ability of a subject, comprising:
a display unit;
an input unit; and
a way-finding test module coupled to said display unit and said input unit, said way-finding test module including
a database for storing two-dimensional map data of a virtual environment that includes a starting point, an end point, and a test route defined from the starting point to the end point,
said database further storing a three-dimensional model of the virtual environment, the three-dimensional model being comprised of surface elements representing features visible in the virtual environment, and
a test processor for controlling said display unit to generate a map image corresponding to the two-dimensional map data of the virtual environment during an initial stage of a way-finding test,
said input unit being operable by the subject during a subsequent stage of the way-finding test to provide control signals to said test processor for traversing a traveling route in the virtual environment, the traveling route starting from the starting point and ending at the end point,
said test processor being responsive to the control signals from said input unit to select from the three-dimensional model the surface elements corresponding to the features in the virtual environment that become visible as the traveling route is traversed, and to control said display unit to generate three-dimensional animation of the traveling route that is being traversed based on the surface elements selected thereby,
said test processor further measuring the duration taken by the subject to traverse the traveling route, and comparing the traveling route with the test route to detect occurrence of the subject getting lost.

2. The system as claimed in claim 1, further comprising at least one auxiliary test module coupled to said display unit and said input unit and selected from the group consisting of a sustained attention test module, a spatial cognitive test module, a set-shifting test module, and a sense-of-direction test module.

3. The system as claimed in claim 2, further comprising a switch module coupled to and operable to activate a selected one of said way-finding test module and said at least one auxiliary test module when evaluating the cognitive ability of the subject.

4. The system as claimed in claim 2, further comprising a response recording module coupled to said way-finding test module and said at least one auxiliary test module for storing responses made by the subject through said input unit when taking tests conducted using said way-finding test module and said at least one auxiliary test module.

5. The system as claimed in claim 2, further comprising an evaluation module for storing a set of comparison data, said evaluation module receiving responses made by the subject through said input unit when taking tests conducted using said way-finding test module and said at least one auxiliary test module, and comparing the responses with the comparison data to generate an evaluation result.

6. The system as claimed in claim 1, wherein said input unit includes at least one of a keyboard, a mouse and a joystick.
